(19) United States
(12) Patent Application Publication
(10) Pub. No.: US 2013/0063426 A1
(43) Pub. Date: Mar. 14, 2013

(54) DISPLAY CONTROL DEVICE, DISPLAY CONTROL METHOD, AND COMPUTER PROGRAM FOR RENDERING THREE-DIMENSIONAL SPACE BY PERSPECTIVE PROJECTION

(71) Applicant: Takeshi NAKAGAWA, Kanagawa (JP)

(72) Inventor: Takeshi NAKAGAWA, Kanagawa (JP)

(73) Assignee: SONY COMPUTER ENTERTAINMENT INC., Tokyo (JP)

(21) Appl. No.: 13/571,626

(22) Filed: Aug. 10, 2012

(30) Foreign Application Priority Data
Sep. 13, 2011 (JP) 2011-199887

(51) Int. Cl. G06T 15/00

(52) U.S. Cl. 345/419

(57) ABSTRACT

A game device, which is an example of a display control device is provided. The game device includes: a rendering unit that renders by perspective projection an object disposed in a three-dimensional space and displays the object on a display device; and a position adjusting unit that adjusts the position for disposing the object in the three-dimensional space so that the object is displayed at a position where the object should be displayed on a screen image of the display device.

### BACKGROUND OF THE INVENTION

1. Field of the Invention

The present invention generally relates to displaying technology, and more particularly, to a display control device, a display control method, and a computer program for rendering three-dimensional space by perspective projection.

2. Description of the Related Art

For personal computers, smart phones, or the like, user interfaces are widely used that display icons, which correspond to data, applications or the like, on a screen image of a display device, and upon receiving an operation input by double-clicking or the like on an icon, display data corresponding to the icon or activate an application corresponding to the icon.

Recent years, portable type game devices, mobile phones, or the like have become popular, and opportunities to handle such user interfaces in daily life have been increased significantly. For user interfaces, not only good operability but also visually fun and easy-to-understand configuration for displaying is strongly required nowadays. The present inventor has recognized a problem that when implementing a three-dimensional user interface scenographically by rendering an object disposed in a three-dimensional space by perspective projection, an adjustment to a position for displaying the object is necessary, and has attained an idea on a display control technology with high user friendliness that can appropriately adjust a position for displaying an object.

### SUMMARY OF THE INVENTION

The present invention addresses the aforementioned issue, and a purpose thereof is to provide a display control technology with high user friendliness.

According to an embodiment of the present invention, a display control device is provided. The game device includes: a rendering unit that renders by perspective projection an object disposed in a three-dimensional space and displays the object on a display device; and a position adjusting unit that adjusts the position for disposing the object in the three-dimensional space so that the object is displayed at a position where the object should be displayed on a screen image of the display device.

Optional combinations of the aforementioned constituting elements, and implementations of the invention in the form of methods, apparatuses, systems, or the like may also be practiced as additional modes of the present invention.

### BRIEF DESCRIPTION OF THE DRAWINGS

FIG. 1 shows an external view of a game device according to an exemplary embodiment;

FIG. 2 shows an external view of the game device according to the exemplary embodiment;

FIG. 3 shows a structure of the game device according to an exemplary embodiment;

FIG. 4A shows an exemplary menu screen image that a menu control unit displays on a display device;

FIG. 4B shows an exemplary map that indicates a correspondence between a position of an input received from a player on the menu screen image shown in FIG. 4A and a function to be activated;

FIG. 5A shows an exemplary menu screen image A that the menu control unit displays on the display device;

FIG. 5B shows an exemplary map that indicates a correspondence between a position of an input received from a player on the menu screen image shown in FIG. 5A and a function to be activated;

FIG. 6A shows an exemplary menu screen image that the menu control unit displays on the display device;

FIG. 6B shows an exemplary map that indicates a correspondence between a position of an input received from a player on the menu screen image shown in FIG. 6A and a function to be activated;

FIG. 7 shows an example of a three-dimensional space rendered by a rendering unit;

FIG. 8 illustrates a method for generating a menu screen image in case that a certain function is adopted as a candidate for selection;

FIG. 9 illustrates a method for generating a menu screen image in case that a certain function is adopted as a candidate for selection;

FIG. 10 shows the movement of objects required in order to generate the menu screen image shown in FIG. 5A;

FIG. 11 shows the movement of objects required in order to generate the menu screen image shown in FIG. 6A; and

FIG. 12 illustrates a method for calculating a position for disposing an object in a three-dimensional space on the basis of a position for displaying the object on a projection plane.

### DETAILED DESCRIPTION OF THE INVENTION

The invention will now be described by reference to the preferred embodiments. This does not intend to limit the scope of the present invention, but to exemplify the invention.

In exemplary embodiments, explanations will be given on a portable game device as an example of a display control device.

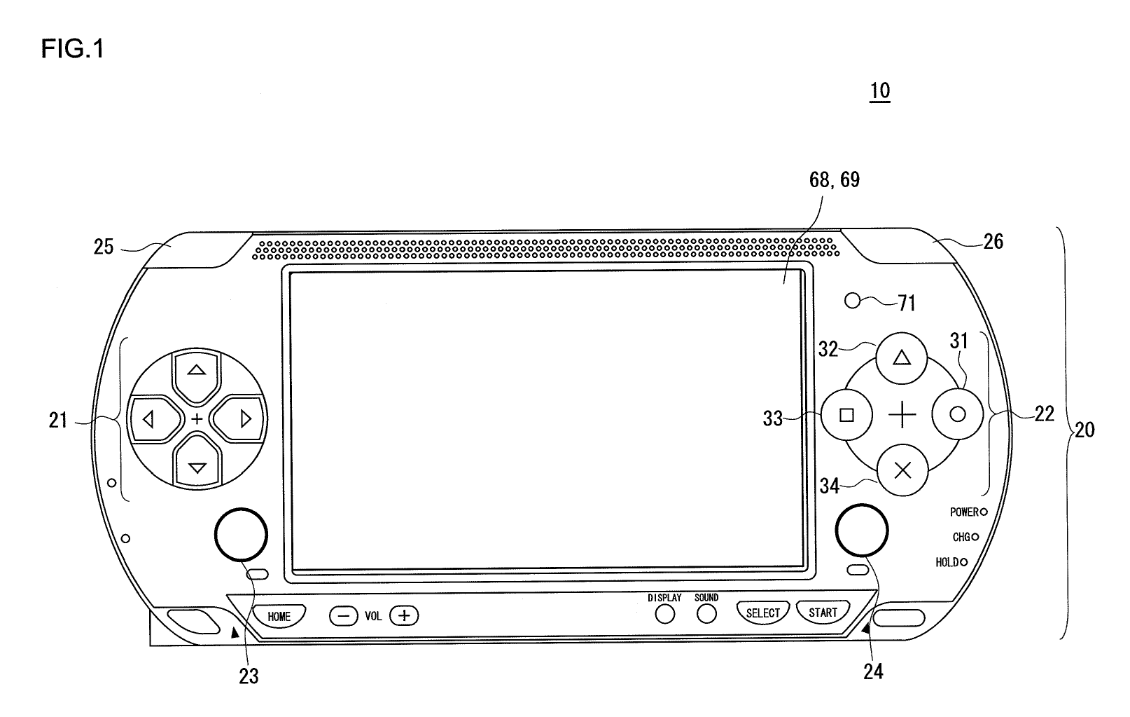

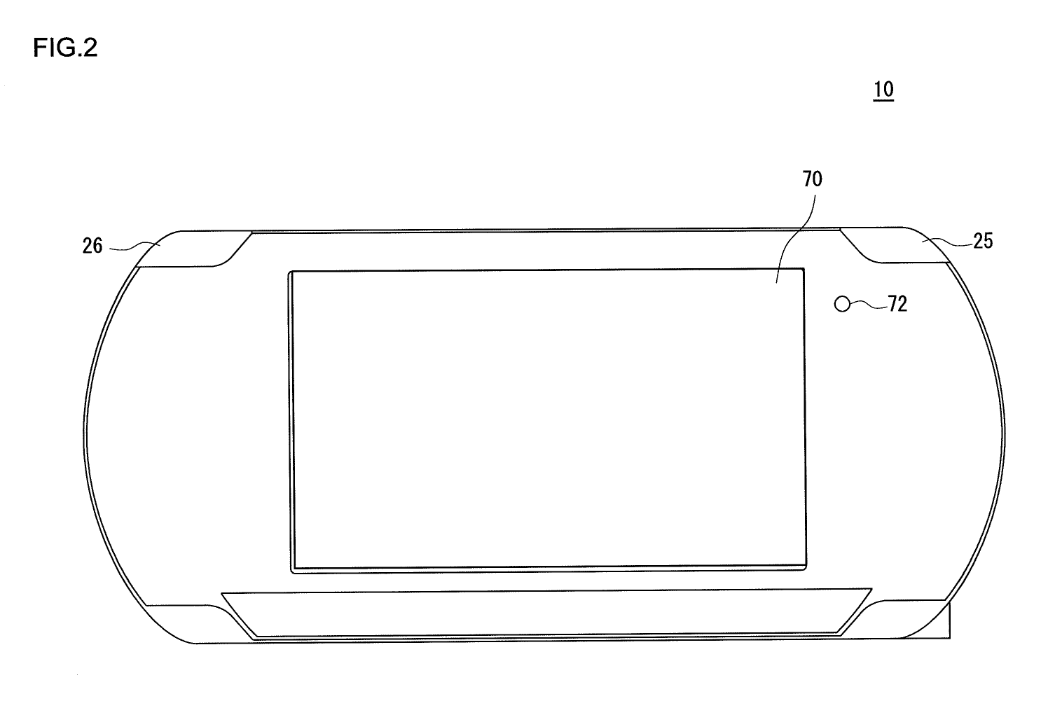

FIGS. 1 and 2 show an external view of a game device 10 according to the exemplary embodiment. The game device 10 shown in FIGS. 1 and 2 are a portable game device that a player holds and uses. As shown in FIG. 1, on the front side of the game device 10 (i.e., the side facing to a player when the player holds and manipulates the game device 10, an input device 20 including directional keys 21, buttons 22, a left analogue stick 23, a right analogue stick 24, a left button 25, a right button 26, or the like, a display device 68, and a front camera 71 are provided. With the display device 68, a touch panel 69 for detecting contact made by a finger or a thumb of the player, a stylus pen, or the like is provided.

The buttons 22 includes a circle button 31, a triangle button 32, a square button 33, and a cross button 34.

As shown in FIG. 2, on the back side of the game device 10, a rear touch panel 70 and a rear camera 72 is provided. Although a display device may be provided also on the back side of the game device 10 in a similar manner with that of the front side, a display device is not provided on the back side of the game device 10 and only the rear touch panel 70 is provided on the back side according to the exemplary embodiment.

A player can, for example, manipulate the buttons 22 with his/her right hand thumb, manipulate the directional keys 21 with his/her left hand thumb, manipulate the right button 26 with his/her right hand index finger or middle finger, manipulate the left button 25 with his/her left hand index finger or middle finger, manipulate the touch panel 69 with his/her thumbs of both hands, and manipulate the rear touch panel 70 with his/her ring fingers or pinky fingers of both hands while holding the game device 10 with his/her both hands. In case of using a stylus pen, or the like, for example, the player can manipulate the touch panel 69 and buttons 22 with the right hand using the stylus pen or using the index finger, manipulate the directional keys 21 with the left hand thumb, manipulate the left button 25 with the left hand index finger or middle finger, and manipulate the rear touch panel 70 with the left hand ring finger or the pinky finger while holding the game device 10 with the left hand.

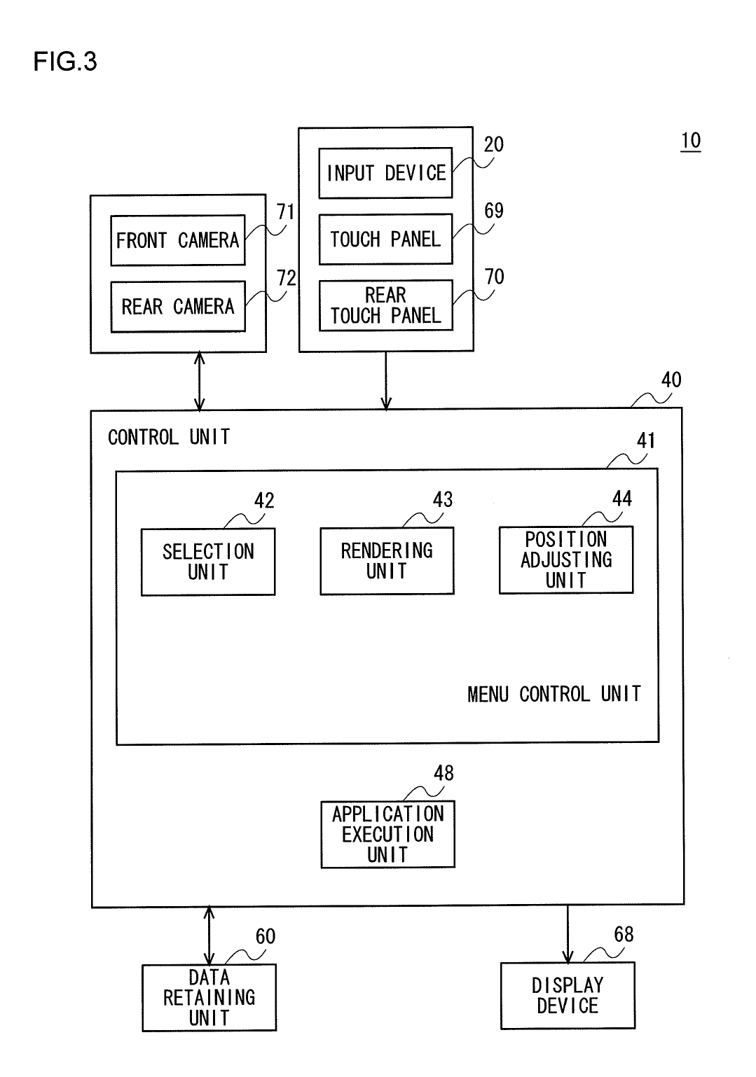

FIG. 3 shows the structure of the game device 10 according to an exemplary embodiment. The game device 10 comprises the input device 20, a control unit 40, a data retaining unit 60, the display device 68, the touch panel 69, the rear touch panel 70, the front camera 71, and the rear camera 72. Those elements are implemented by a CPU of a computer, memory, a program loaded into the memory, or the like in terms of hardware components. FIG. 3 depicts functional blocks implemented by cooperation of these components. Therefore, it will be obvious to those skilled in the art that the functional blocks may be implemented in a variety of ways, by hardware only, software only, or a combination thereof.

The touch panel 69 may be any type of touch panel, such as, matrix switch type, resistance film type, surface acoustic wave type, infrared type, electromagnetic induction type, electrical capacitance type, or the like. The touch panel 69 outputs coordinates of positions where inputs are detected at predetermined time intervals. The rear touch panel 70 may also be any type of touch panel. The rear touch panel 70 outputs coordinates of positions where inputs are detected and the strength of the input (pressure) at predetermined time intervals. The position and the strength of the input detected by the touch panel 69 and the rear touch panel 70 from the player may be calculated by a device driver or the like (not shown) provided in the touch panel 69 and the rear touch panel 70, or in the control unit 40.

The front camera 71 takes an image of the front side of the game device 10. The rear camera 72 takes an image of the back side of the game device 10.

The control unit 40 comprises a menu control unit 41 and an application execution unit 48. The menu control unit 41 comprises a selection unit 42, which is an example of a determining unit, a rendering unit 43, and a position adjusting unit 44.

The menu control unit 41 displays on a display device a menu screen image of a variety of functions provided by the game device 10, and receives information on selection of a function to be executed from a player. The application execution unit 48 reads from the data retaining unit 60 a program of an application selected in accordance with the instruction of the player received by the menu control unit 41, and executes the program, accordingly.

In order to generate a menu screen image of various functions provided by the game device 10, the rendering unit 43 disposes objects corresponding to the various functions in a virtual three-dimensional space, defines a view point position and a projection plane, and renders the objects by perspective projection. The selection unit 42 acquires the position of a touch input made by a player on the touch panel 69, refers to a map indicating a correspondence between the position of an input and a function to be activated, determines a function that corresponds to the input position, and defines the determined function as a candidate for selection. If a player moves his/her finger or thumb while keeping contact with the touch panel 69, the selection unit 42 switches, in accordance with the movement of the touch input position, the candidate for selection to a function that corresponds to the current input position. If the selection unit 42 acquires information indicating that the finger or thumb of the player is moved off the touch panel 69 so that the touch input onto the touch panel 69 is switched off, the selection unit 42 finalizes a selection of a function corresponding to the input position when the touch input is switched off, i.e., finalizes a selection of a function that has been determined to be the candidate for selection immediately before the switch-off, and the selection unit 42 notifies the application execution unit 48 of an instruction to execute the function, accordingly. In another example, the selection unit 42 may select a function to be a candidate for selection on the basis of the position of a first touch input, and may finalize, upon receiving another input on the position corresponding to the function that has been determined to be the candidate for selection, the selection of the function. As will be described later, the position adjusting unit 44 adjusts a position for disposing an object that is rendered by the rendering unit 43 by perspective projection.

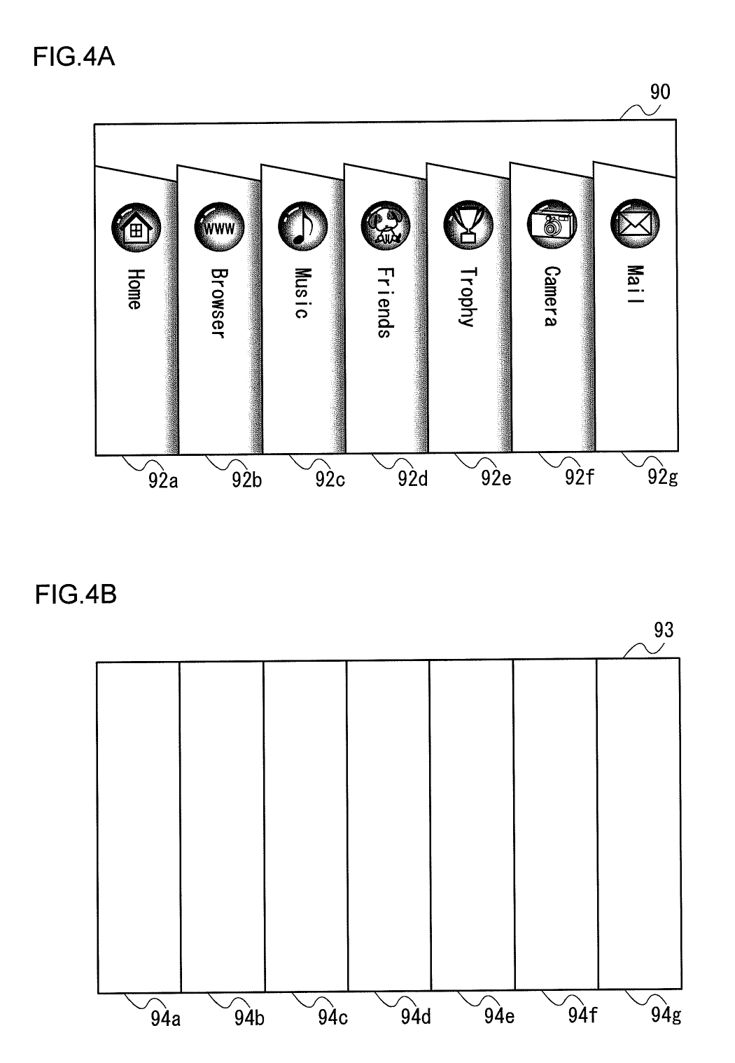

FIG. 4A shows an exemplary menu screen image that the menu control unit 41 displays on the display device 68. On the menu screen image 90, objects 92a-92g are displayed that indicate various functions provided by the game device 10. FIG. 4B shows an exemplary map that indicates a correspondence between a position of an input received from a player on the menu screen image shown in FIG. 4A and a function to be activated. In the menu screen image 90 shown in FIG. 4A where a candidate for selection is not yet selected, rectangular input regions 94a-94g having the same area are allocated to respective functions. The objects 92 in the menu screen image 90 and the input regions 94 allocated to respective functions in the map 93 are equal in width. If the selection unit 42 acquires the position of an input made by a player on the touch panel 69, the selection unit 42 determines which input region in the map 93 the input position belongs, and defines a function that corresponds to the determined input region as a candidate for selection. The input regions 94 may be in any size and in any shape. An input region that corresponds to a function used frequently (e.g., the input region 94a for which a function for displaying a home screen image is allocated) may be configured so as to have an area larger than that of other input regions.

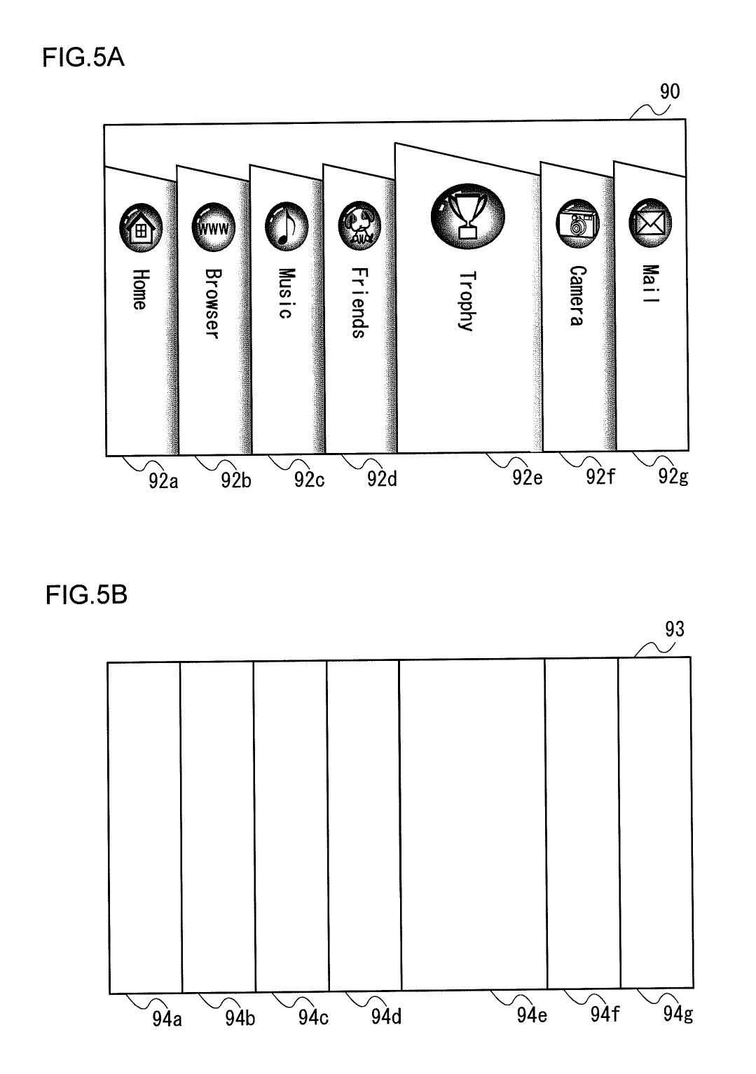

FIG. 5A shows an exemplary menu screen image that the menu control unit 41 displays on the display device 68. FIG. 5A shows an exemplary menu screen image 90 where a function corresponding to the object 92e is set as a candidate for selection. The rendering unit 43 displays a menu screen image 90 that presents the object 92e corresponding to a function set as the candidate for selection as if the object 92e pops up toward the player.

FIG. 5B shows an exemplary map for the menu screen image shown in FIG. 5A. In the menu screen image 90 shown in FIG. 5A where a candidate for selection is selected, the input region 94e having large area is allocated to a function that is set as a candidate for selection so that a player can readily enter instruction for activating the function that is set as the candidate for selection. Therefore, to other functions that have not set as a candidate for selection, input regions having an area smaller than that shown in FIG. 4B are allocated. Corresponding thereto, also in the menu screen image 90, display regions for objects corresponding to functions that have not set as a candidate for selection become narrower than those of the menu screen image shown in FIG. 4A, and the display region for the object corresponding to the function that has set as a candidate for selection becomes broader. The rendering unit 43 displays respective objects so that the object 92e corresponding to a function that is set as a candidate for selection is slid out gradually toward a player while the area of the display region thereof increases, and so that areas of the other objects decreases gradually and the other objects moves right or left. In accordance with the animation displayed by the rendering unit 43 as if the display region of the object 92e gradually increases, the selection unit 42 changes respective input regions so that the input region 94e corresponding to the object 92e gradually becomes broader, and the other input regions gradually become narrower and move left or right. That is, each of the display regions of objects 92a-92g and input regions 94a-92g corresponding thereto are controlled so as to be in accordance with each other even while they are displayed in animation.

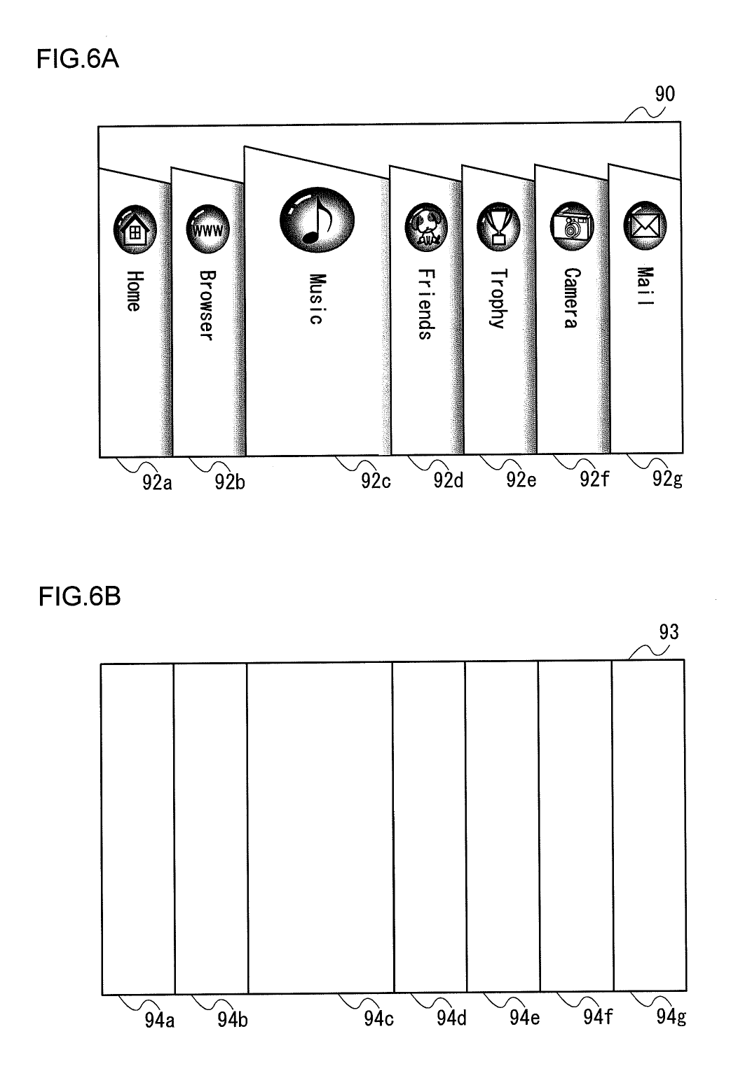

FIG. 6A shows an exemplary menu screen image that the menu control unit 41 displays on the display device 68. If the rendering unit 43 acquires an input by a player onto the display region of the object 92c in the menu screen image 90 shown in FIG. 4A or FIG. 5A, the rendering unit 43 displays a menu screen image 90 that appears as if the object 92c pops up toward the player. When the menu screen image 90 of FIG. 5A is switched to the menu screen image of FIG. 6A, the rendering unit 43 may first display the menu screen image 90 of FIG. 4A changed back by displaying the object 92e as if the object retreats back and then may display the menu screen image 90 of FIG. 6A by displaying the object 92c as if it is pulled toward the player. FIG. 6B shows an exemplary map for the menu screen image shown in FIG. 6A. In a similar manner as that of the map 93 shown in FIG. 5B, the input regions 94c having large area is allocated to a function that is set as a candidate for selection.

As described above, according to the exemplary embodiment, if a player moves his/her finger or thumb while keeping contact with the touch panel 69, in accordance with the change of an input position, the candidate for selection is switched to a function that corresponds to a current input position. For example, if a player moves a finger or thumb to left on the menu screen image 90 shown in FIG. 4A without detaching the finger or thumb from the touch panel 69, when the input position reaches the display region of the object 92d, the function corresponding to the object 92d is adopted as a candidate for selection, and objects are displayed in animation where the object 92e is reduced and the object 92d is enlarged. If a player moves the finger or thumb further to left and if the input position reaches the display region of the object 92c, the function corresponding to the object 92c is adopted as a candidate for selection, and objects are displayed in animation where the object 92d is reduced and the object 92c is enlarged so that the menu screen image is transformed into the menu screen image 90 shown in FIG. 6A. In this process, the input regions 94 are also changed in accordance with the change of the display regions for the objects 92. According to the exemplary embodiment, the menu screen image 90 is divided so that any part of the menu screen image 90 belongs one of the input regions 94 as shown in FIG. 4B, FIG. 5B, and FIG. 6B. Therefore, once a player touches the menu screen image 90, when the player detaches the finger or the thumb at a certain position, a function allocated the input region to which the position belongs is activated inevitably. According to another exemplary embodiment, a region to which no function is allocated may be provided. In this case, after a player touches the touch panel 69 if the player moves the input position to a region to which one of the functions are allocated, that function is adopted as a candidate for selection. If the player moves the input position to the region to which no function is allocated, a candidate for selection is canceled. In a status where a candidate for selection has been canceled, if the finger or the thumb is detached from a region to which no function is allocated, no function is activated.

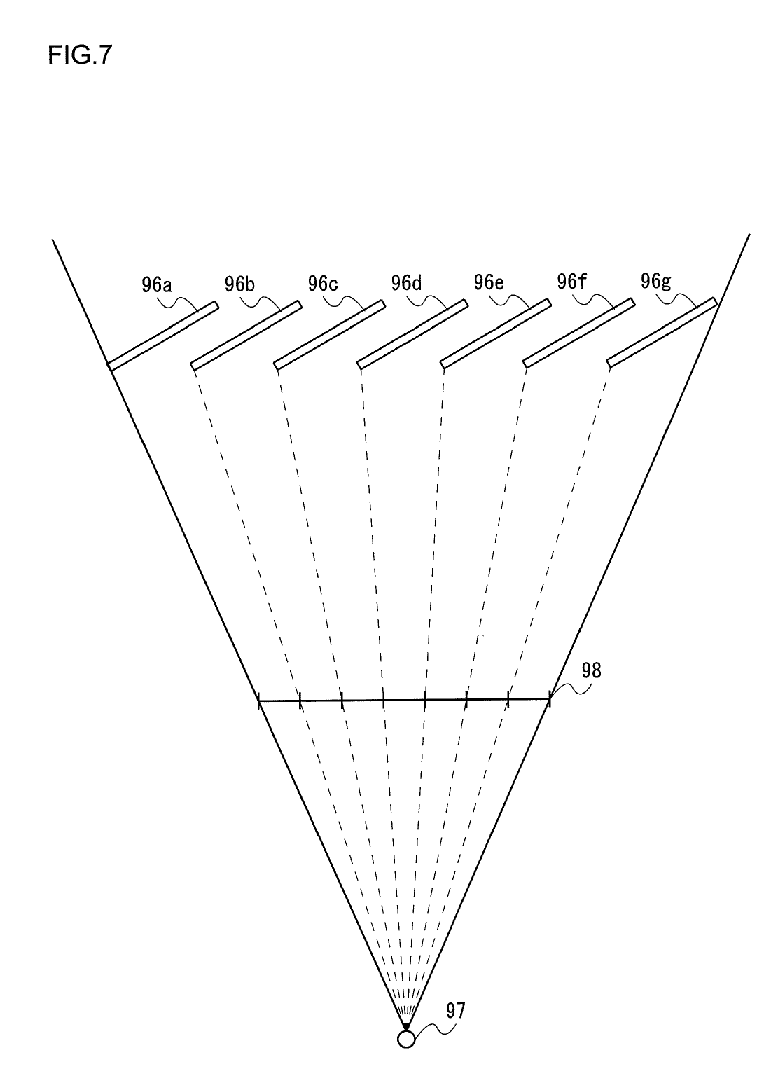

FIG. 7 shows an example of a three-dimensional space to be rendered by the rendering unit. In a virtual three-dimensional space, board-like objects 96a-96g are disposed as objects corresponding to respective functions displayed on the menu screen image. The rendering unit 43 defines a view point position 97 and a projection plane 98 and renders the objects 96a-96g by perspective projection so as to generate the menu screen image 90 shown in FIG. 4A. The position of the projection plane 98 may be any position. For example, the projection plane 98 may be provided on the back of the object 96. Any view point position 97 and any projection plane 98 can be sufficiently adopted as far as they are defined in consideration of the size of the object 96 and the size of the screen image to be displayed.

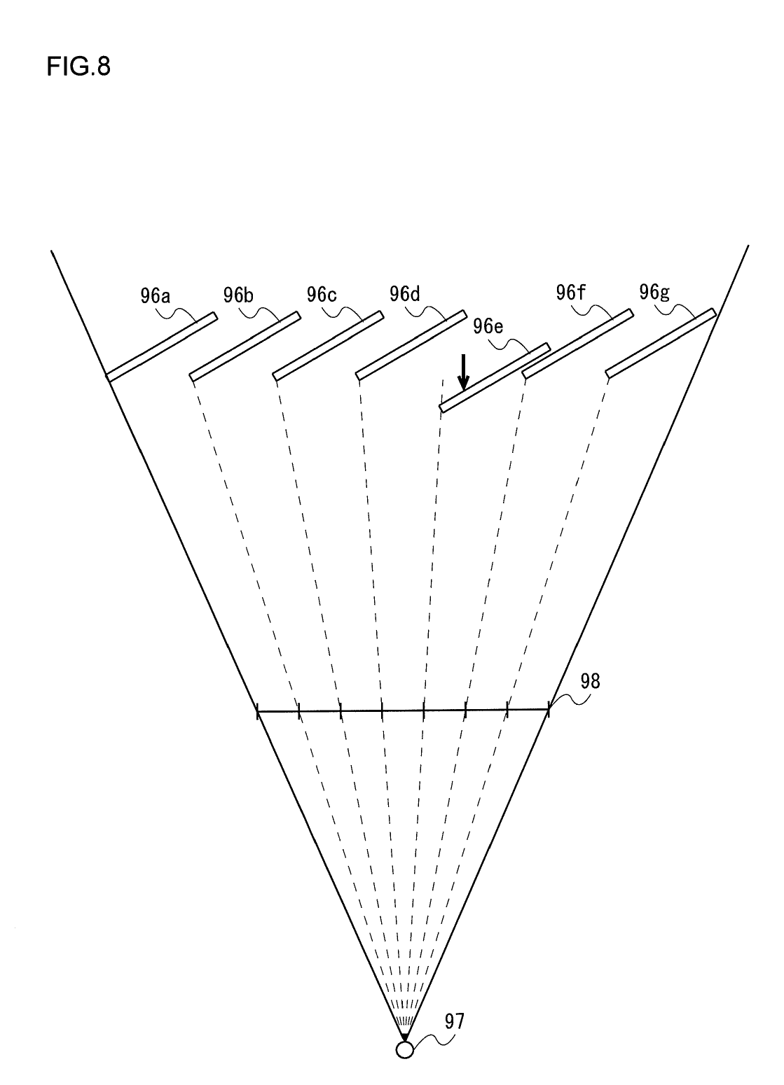

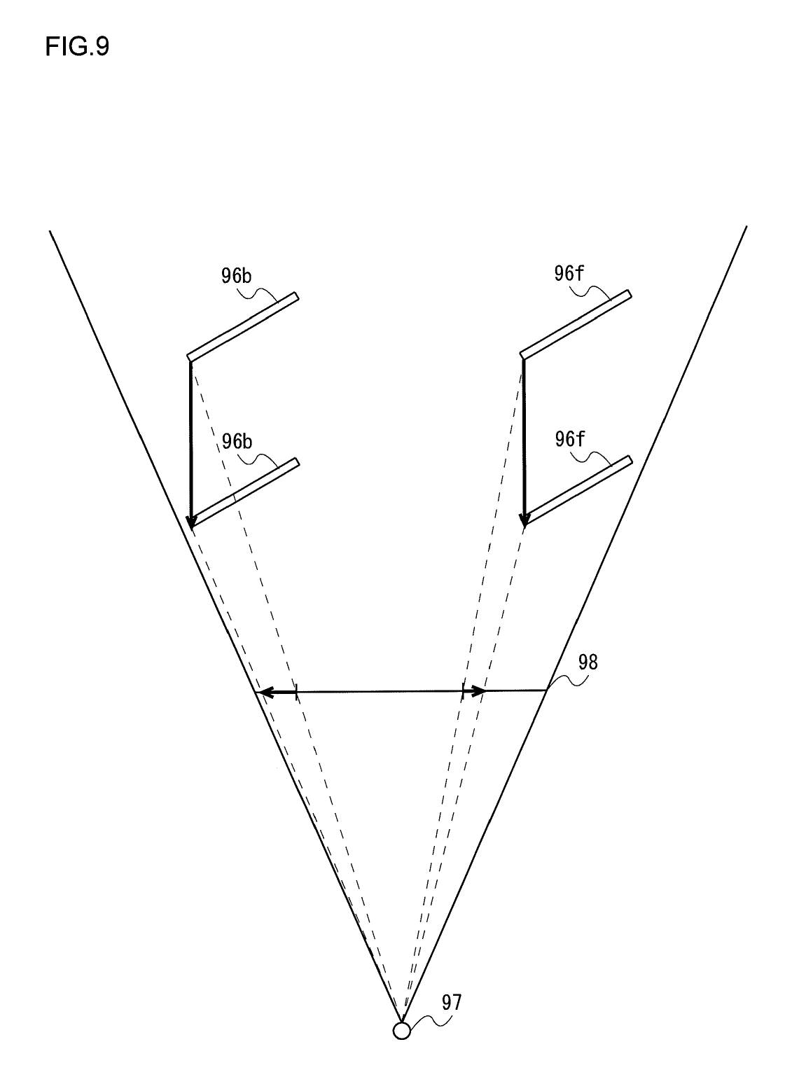

FIGS. 8 and 9 illustrate a method for generating a menu screen image in case that a certain function is adopted as a candidate for selection. If an input onto an input region corresponding to the display region of the object 96e is received and a function corresponding to the object 96e is adopted as a candidate for selection by the selection unit 42, the object 96e may be moved toward the player so as to come close to the view point position 97 in order to display an enlarged object 96e in the menu screen image. However, if an object is moved in the depth direction in perspective projection, the projection position of the object becomes misaligned as shown in FIG. 9. For example, if the object 96b that is displayed in the left half of the projection plane 98 is moved toward a player, the display position of the object is shifted to the left on the projection plane 98. If the object 96f that is displayed in the right half of the projection plane 98 is moved toward the player, the display position of the object is shifted to the right on the projection plane 98. The amount of deviation of the display position of an object on the projection plane 98 becomes larger as the display position of the object departs from the center of the projection plane 98. Therefore, in order to generate a menu screen image 90 wherein input regions and display regions of objects are in accordance with each other as shown in FIGS. 4-6, it is required to move an object on a plane parallel to the projection plane 98 in consideration of the shift of display position accompanied to the movement in the depth direction so that the display position is in accordance with the input region. Although the object 96e is moved toward a player within the back-side area of the projection plane 98 in FIG. 8, in another exemplary embodiment, the object 96e may be moved to the front of the projection plane 98.

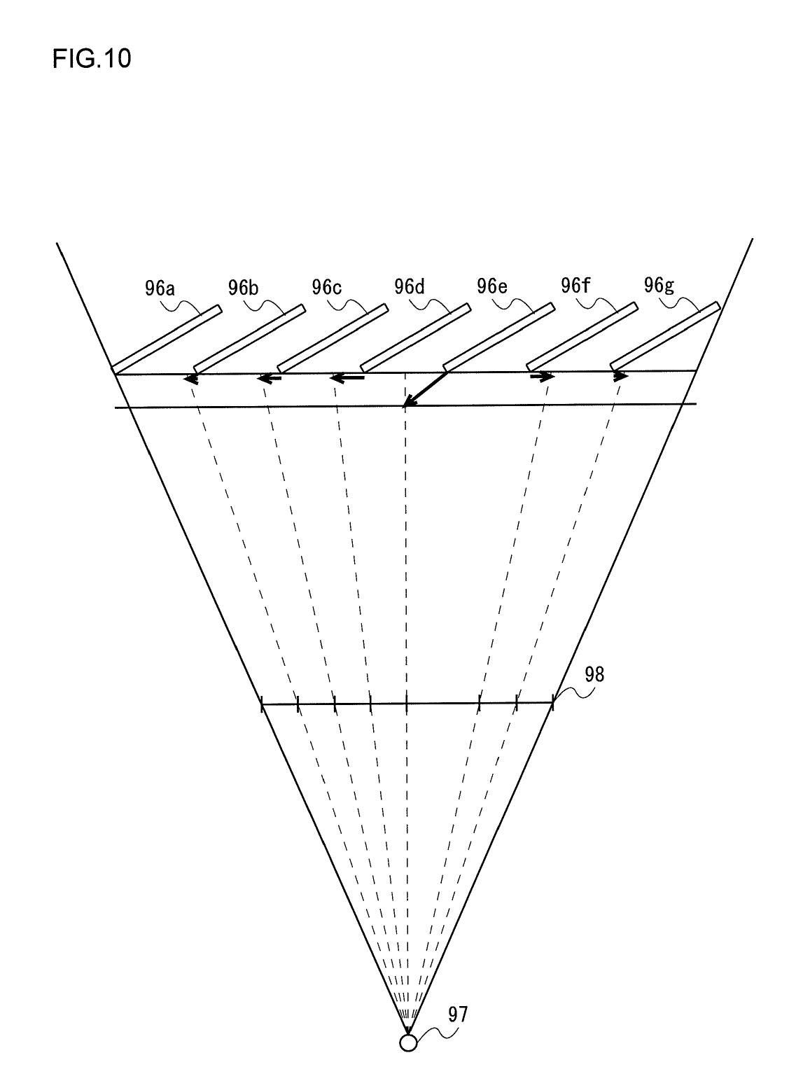

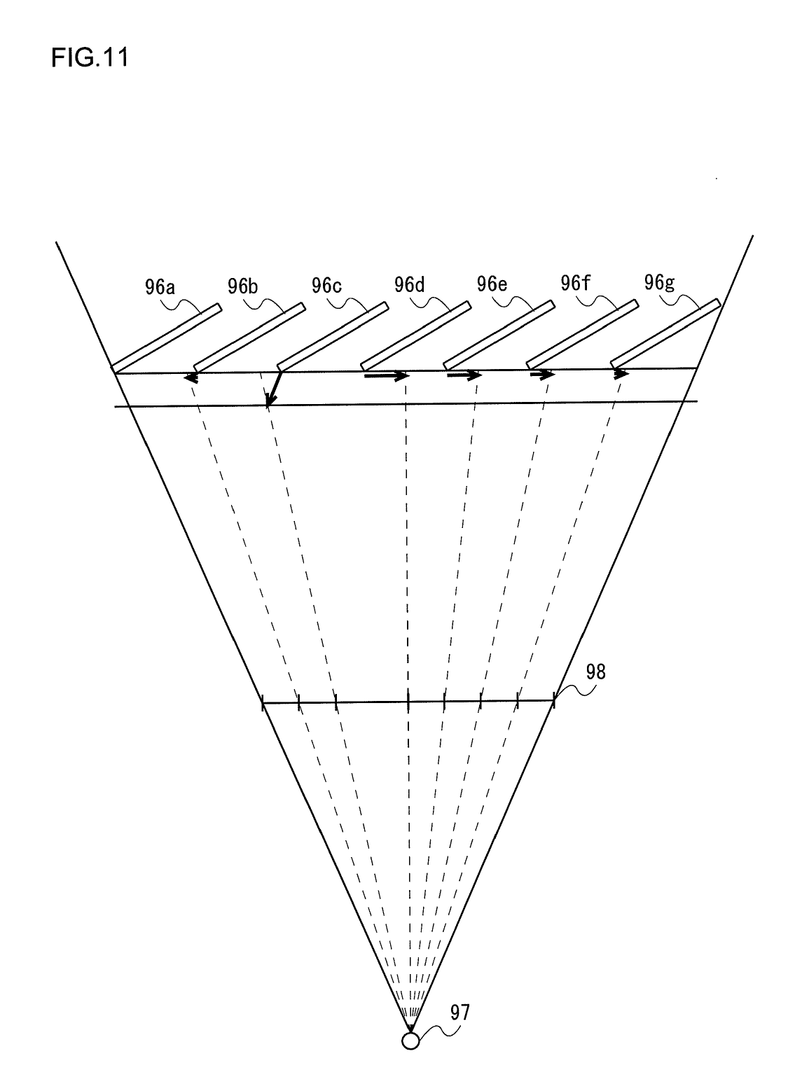

According to the exemplary embodiment, an object corresponding to a function that is not adopted as a candidate for selection is displayed in narrower width. Therefore, it is also required to move objects corresponding to functions that is not adopted as a candidate for selection on a plane parallel to the projection plane 98 so that the distance between the objects becomes narrower. FIG. 10 shows the movement of the objects 96 required in order to generate the menu screen image 90 shown in FIG. 5A. FIG. 11 shows the movement of the objects 96 required in order to generate the menu screen image 90 shown in FIG. 6A. The position adjusting unit 44 calculates the position of the objects 96 in the three-dimensional space so that the objects 92 are displayed at positions corresponding to respective input regions 94 in the map 93 on the projection plane 98 as shown in FIG. 5A or FIG. 6B, and moves the objects 96 to the calculated positions, accordingly.

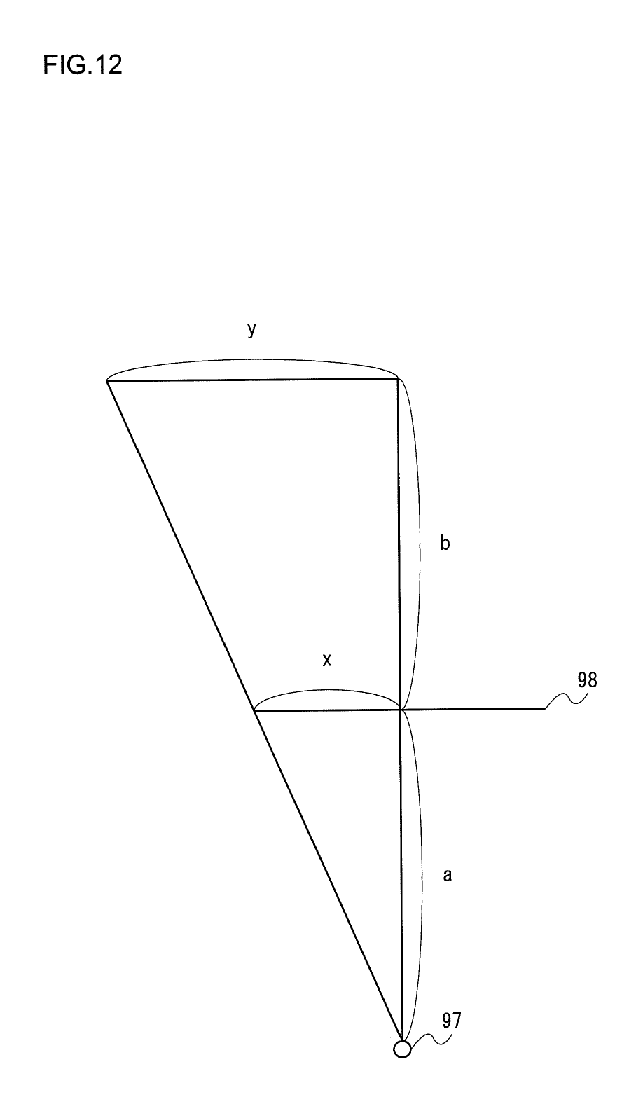

FIG. 12 illustrates a method for calculating the position for disposing an object in a three-dimensional space on the basis of a position for displaying the object on a projection plane 98. Let “a” be the distance from the view point position 97 to the projection plane 98, “b” be the distance in depth direction from the projection plane 98 to the position for disposing the object, “x” be the coordinates of a position where the object should be disposed on the projection plane 98, and “y” be the coordinate of a position to dispose the object in three-dimensional space.

Then a:(a+b)=x:y.

Thus, y is calculated by equation:

y=x(a+b)/a=x(1+b/a).

By using the above equation, the position adjusting unit 44 can calculate positions for disposing objects 96 in accordance with the positions of respective input regions 94 on the map 93.

In this manner, according to the exemplary embodiment, by adjusting positions for disposing objects in a three-dimensional space in accordance with positions where the objects should be displayed on a screen image, the objects can be displayed at positions where the objects should be displayed even in case that the objects are rendered by perspective projection. Further, a correspondence between a position for displaying an object and an input position can be correctly adjusted in a scenographical three-dimensional user interface that is rendered by perspective projection, and an input for an object can be received appropriately. According to the exemplary embodiment, a plurality of board-like objects are displayed so that the objects are superimposed in a slanted manner. Therefore, even if the positions for disposing objects is moved so that the display positions of the left sides of the objects are in accord with the left sides of the input regions, the right side of the objects are lapped over by other objects and thus cannot be seen. This decreases discomfort caused by movement of arrangement position.

Given above is an explanation based on the exemplary embodiments. These embodiments are intended to be illustrative only and it will be obvious to those skilled in the art that various modifications to constituting elements and processes could be developed and that such modifications are also within the scope of the present invention.

According to the exemplary embodiment, an explanation has been given on an example where the position adjusting unit 44 adjusts a position for displaying an object when the rendering unit 43 renders the objects. In another exemplary embodiment, the position for displaying an object may be adjusted in advance by using the above mathematical expression, and may be stored in the data retaining unit 60 or the like. According to yet another exemplary embodiment, a movement trajectory of an object of which arrangement position is adjusted may be stored in the data retaining unit 60 as animation data, moving image data, or the like. When a candidate for selection is selected by an input from a player, the rendering unit 43 may read the animation data or the moving image data from the data retaining unit 60 and may play back the data.

What is claimed is:

1. A display control device comprising:
a rendering unit operative to render, by perspective projection, an object disposed in a three-dimensional space and operative to display the object on a display device; and
a position adjusting unit operative to adjust the position for disposing the object in the three-dimensional space so that the object is displayed at a position where the object should be displayed on a screen image of the display device.

2. The display control device according to claim 1, further comprising a determining unit operative to acquire a position of input from an input device that detects input by a user on the screen image and operative to determine whether or not the position of the input is within a predetermined input region,
wherein the position adjusting unit adjusts the position for disposing the object in the three-dimensional space so that the input region and the display region of the object are in accordance with each other.

3. The display control device according to claim 2, wherein
the rendering unit renders a plurality of objects and displays the plurality of objects on the display device,
the determining unit determines to which of a plurality of input regions that respectively correspond to the plurality of objects the position of the input belongs,
the rendering unit renders a target object corresponding to the input region determined by the determining unit by moving the target object in the three-dimensional space so that the target object is disposed close to a view point position and so that the target object is displayed larger, and
the position adjusting unit moves the position for disposing the target object, which is displayed larger, in the three-dimensional space on a plane parallel to a projection plane so that the display region of the target object is in accord with the input region corresponding to the target object.

4. A display control method comprising:
rendering, by perspective projection, an object disposed in a three-dimensional space and displaying the object on a display device; and
adjusting the position for disposing the object in the three-dimensional space so that the object is displayed at a position where the object should be displayed on a screen image of the display device.

5. A display control program embedded on a non-transitory computer-readable recording medium, allowing a computer to function as:
a rendering unit operative to render, by perspective projection, an object disposed in a three-dimensional space and operative to display the object on a display device; and
a position adjusting unit operative to adjust the position for disposing the object in the three-dimensional space so that the object is displayed at a position where the object should be displayed on a screen image of the display device.

6. A non-transitory computer readable recording medium encoded with the program according to claim 5.
